(19) United States
(12) Patent Application Publication
(10) Pub. No.: US 2007/0083028 A1
(43) Pub. Date: Apr. 12, 2007

(54) Reactive systems, their preparation and use

(75) Inventors: Christoph Gurtler, Koln (DE); Thomas Feller, Solingen (DE); Thomas Stingl, Montabaur (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/543,670

(22) Filed: Oct. 5, 2006

(30) Foreign Application Priority Data
Oct. 10, 2005 (DE) 102005048823.4

(51) Int. Cl. C08G 18/00

(52) U.S. Cl. 528/44

(57) ABSTRACT

The present invention relates to new blocked polyurethane (PU) prepolymers free from elimination products, to a process for preparing them and to their use as a starting component in the production of polyurethane plastics and surface coatings.

### CROSS-REFERENCE TO RELATED APPLICATION

This application claims priority under 35 U.S.C. §119 to German application DE 10 2005 048823.4, filed Oct. 10, 2005.

### FIELD OF THE INVENTION

The present invention relates to new blocked polyurethane (PU) prepolymers free from elimination products, to a process for preparing them and to their use as a starting component in the production of polyurethane plastics and surface coatings.

### BACKGROUND OF THE INVENTION

Polyurethane (PU) prepolymers represent valuable building blocks for crosslinking with polyols or amines for various fields of application. Using these prepolymers it is possible to produce high-quality polyurethane or polyurea coatings. For 1K [1-component] PU, blocked prepolymers are of particular interest.

Examples of possible blocking agents for NCO groups include alcohols, lactams, oximes, malonic esters, alkyl acetoacetates, triazoles, phenols, imidazoles, pyrazoles and also amines, such as butanone oxime, diissopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-methyl-, N-ethyl-, N-(iso)propyl-, N-n-butyl-, N-isobutyl-, N-tert-butyl-benzylamine or 1,1-dimethyl-benzylamine, N-alkyl-N-1,1-dimethylmethylphenylamine, adducts of benzylamine with compounds having activated double bonds such as malonic esters, N,N-dimethylaminopropylbenzylamine and other optionally substituted benzylamines containing tertiary amino groups, and/or dibenzylamine.

These blocking agents, known to the skilled person, are reversible blocking agents, which means that the resultant reversibly blocked polyurethane prepolymers have the disadvantage that, after reaction with a curing agent, such as a polyamine, the blocking agent is released again.

The blocking agent may therefore escape or be leached out over time, which is a great disadvantage not least for the mechanical properties of the plastic.

This disadvantage can be circumvented by the use of prepolymers free from elimination products, where the blocking agent is not released in the course of curing. Examples thereof are systems blocked with CPME (cyclopentanone 2-carboxymethyl ester) and CPEE (cyclopentanone 2-carboxyethyl ester). Examples of such systems have been described in German Laid-Open Specifications DE 10260299 A1, DE 10132016 A1, DE 10226926 A1 and DE 10260300 A1.

The known systems, however, particularly those based on HDI, have a relatively high viscosity, owing to intermolecular hydrogen bond formation on the part of the urethane groups, which is a great disadvantage for the processing of such reactive systems.

One option for improving this is to use solvents to lower the viscosity, but that is environmentally and economically undesirable.

It was an object of the present invention, therefore, to provide new, lightfast, HDI-based prepolymers which are free from elimination products, which have a much lower viscosity than the existing prepolymers and which are therefore suitable for solvent-free or low-solvent systems.

### SUMMARY OF THE INVENTION

This object has now been achieved by means of a special preparation process for such prepolymers, in particular with CPEE or CPME blocking.

Surprisingly it has been found that prepolymers which have been worked up by continuous distillation in order to separate off residual monomers, prior to blocking with the blocking agent CPME or CPEE, possess a comparatively low viscosity.

The invention provides a process for preparing blocked polyurethane prepolyrners, by reacting
I)
   A) linear aliphatic isocyanates with
   B) one or more polyols optionally in the presence of one or more catalysts to give NCO-functional prepolymers and
II) then subjecting these prepolymers to continuous distillation, thus lowering residual monomer content to less than 10% by weight of the total amount of the solvent-free prepolymer, preferably to less than 5%, more preferably to less than 1% by weight and
III) then reacting the free NCO groups of the prepolymers obtained by step II), optionally in the presence of one or more catalysts, with a blocking agent comprising at least one CH-acidic cyclic ketone of the general formula (1), 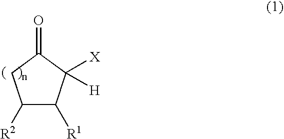
   in which
   X is a mesomerically or inductively electron-withdrawing group,
   R¹ and R² independently of one another can be a hydrogen atom, a saturated or unsaturated aliphatic or cycloaliphatic, an optionally substituted aromatic or araliphatic radical and can each contain up to 12 carbon atoms and optionally up to 3 heteroatoms of the elements oxygen, sulphur and nitrogen, and can optionally be substituted by halogen atoms, and
   n is an integer from 0 to 5.

### DETAILED DESCRIPTION OF THE INVENTION

In component A it is possible to use linear aliphatic isocyanates having a functionality of preferably ≧2 and a preferred chain length of C4 to C10; with particular preference A) comprises hexane diisocyanate (hexamethylene diisocyanate, HDI); with very particular preference only HDI is used in A).

In component B) of the process of the invention it is possible to use the relatively high molecular weight polyether polyols, polyester polyols, polyacrylate polyols and polycarbonate polyols that are known per se to the skilled person from polyurethane chemistry.

When using polyether polyols in component B) the polyether polyols employed have a number-average molecular weight of preferably 300 to 20 000 g/mol, more preferably 1000 to 12 000 g/mol, very preferably 2000 to 6000 g/mol, and are obtainable in conventional manner by alkoxylating suitable starter molecules.

Examples of suitable starter molecules are simple polyols such as ethylene glycol, sorbitol and also low molecular weight, hydroxyl-containing esters of such polyols with aliphatic or aromatic dicarboxylic acids, and also low molecular weight ethoxylation or propoxylation products of simple polyols of this kind, or any desired mixtures of such modified or unmodified alcohols, water, organic polyamines having at least two N—H bonds, or any desired mixtures of such starter molecules.

Suitability for the alkoxylation is possessed by cyclic ethers such as tetrahydrofuran and/or alkylene oxides such as ethylene oxide, propylene oxide, butylene oxide, styrene oxide or epichlorohydrin, which can be used in any order or else in a mixture for the alkoxylation. Preferred for the alkoxylation are ethylene oxide, propylene oxide and tetrahydrofuran (THF).

Preference is given to polyether polyols of the aforementioned kind based on difunctional starter molecules, the polyether polyols having an unsaturated end group content of less than or equal to 0.02 milliequivalents per gram of polyol, more preferably less than or equal to 0.015 milliequivalents per gram of polyol, very preferably less than or equal to 0.01 milliequivalents per gram of polyol (determination method: ASTM D2849-69). These polyether polyols have a particularly narrow molecular weight distribution, i.e. a polydispersity (PD=M_{w}/Mₙ) of preferably 1.1 to 1.5 and an OH functionality of preferably ≧1.90, more preferably ≧1.95.

Such polyether diols are preparable in conventional manner by alkoxylating suitable starter molecules, especially using double metal cyanide catalysts (DMC catalysis). This is described for example in U.S. Pat. No. 5,158,922 (e.g. Example 30) and EP-A 0 654 302 (p. 5, 1. 26 to p. 6, 1. 32).

Besides the abovementioned polyeiher diols it is of course also possible to use higher polyfunctional polyether polyols having a higher OH functionality.

Highly suitable for the process of the invention are what are called C4 polyethers, such as, for example, compounds of Poly THF (BASF AG, DE). These compounds are notable for a polyalkylene oxide unit having 4 carbon atoms.

Likewise suitable as compounds of component B are polyester polyols. Thus, for example, with polyester polyols which are obtained by esterification with a diol (e.g. hexanediol, cyclohexanedimethanol, 3-methylpentanediol, 1,3-butanediol, 1,4-butanediol) or higher polyhydric alcohols (e.g. trimethylpropane or pentaerythritol) and ε-caprolatone it is possible to obtain blocked prepolymers of low viscosity. In this case the length of the polyester polyol can be determined by the number of ε-caprolatone units used. The esterification can be accelerated if desired by metal catalysts, such as Sn(II) ethylhexanoate.

The preferred molecular weight of the polyester polyols (number average) is ≦1000 g/mol. The preferred functionality of the polyester polyols is 2 to 3.

Polyacrylate polyols as well are suitable for the preparation of the blocked prepolymers (component B). The polyacrylate polyols have a number-average molecular weight of 200 to 10 000 g/mol, more preferably 200 to 6000 g/mol and very preferably from 200 to 2500 g/mol. The functionality of the polyacrylate polyols used is preferably 1.6 to 3.8, more preferably 1.8 to 3.5. The OH number of these polyacrylate polyols is preferably 15 to 150, more preferably 20 to 100 and very preferably 40 to 80. Suitable examples include Acryflow® P60 and P90 (commercial products of Lyondell, US).

Polycarbonate polyols too are suitable for the synthesis of the prepolymers of the invention (component B). These polyols have aliphatic polycarbonate polyol units which are distinguished by particularly good mechanical stability and chemical resistance. The functionality of the polycarbonate polyols used is preferably 1.6 to 3.8, more preferably 1.8 to 3.5. These polycarbonate polyols have a number-average molar weight of preferably 100 to 6000 g/mol and more preferably from 100 to 4000 g/mol. The OH number is dependent on the functionality of the polycarbonate polyols and amounts typically to 20 to 900. Suitable examples include Desmophen® C2200 (linear aliphatic polycarbonate diol having terminal hydroxyl groups and having an average molecular weight of 2000 g/mol and functionality of 2), XP 2586 (linear polycarbonate polyol of low molecular weight (Mₙ=about 1000 g/mol and functionality 2), Desmophen® C 1200 (linear aliphatic polycarbonate-polyester diol, equivalent weight 1000 g/mol, both Bayer MaterialScience AG, DE.

As optionally used catalysts it is possible to employ the catalysts known per se from polyurethane chemistry to accelerate the NCO/OH reaction, especially organometallic compounds such as dibutyltin(II) diacetate, dibutyltin(II) dilaurate or tertiary amines such as triethylamine or diazabicyclooctane.

Blocking agents used are CH-acidic cyclic ketones of the general formula (1), 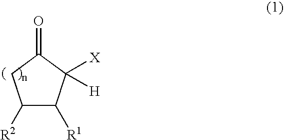
in which
X is a mesomerically or inductively electron-withdrawing group,
R¹ and R² independently of one another can be a hydrogen atom, a saturated or unsaturated aliphatic or cycloaliphatic, an optionally substituted aromatic or araliphatic radical and can each contain up to 12 carbon atoms and optionally up to 3 heteroatoms of the elements oxygen, sulphur and nitrogen, and can optionally be substituted by halogen atoms, and
n is an integer from 0 to 5.

The electron-withdrawing group X may comprise all substituents which through mesomeric or inductive effects lead to CH-acidity on the part of the α hydrogen. A mesomeric effect in the sense of the invention is produced by a substituent which has an electron pair gap, so that it withdraws electron pairs from the system and so reduces the electron density of the system. These substituents increase the acid strength, since they stabilize the resultant acid radical anions by spreading the negative charge. An inductive effect in the sense of the invention is produced by electron-withdrawing substituents; the inductive group in this case possesses a negative partial charge, so that, consequently, the electron density of the system is reduced and in this way it acquires a positive partial charge.

These groups may be, for example, ester groups, sulphoxide groups, sulphone groups, nitro groups, phosphonate groups, nitrile groups, isonitrile groups or carbonyl groups. Preference is given to nitrile and ester groups, particular preference to methyl carboxylate and ethyl carboxylate groups.

The compounds of the general formula (1) may optionally also contain heteroatoms in the ring, such as oxygen, sulphur or nitrogen atoms, with oxygen being preferred for this case, thus resulting in the structural element of a lactone. With preference, however, the ring has no heteroatom.

Preferably n=1 or n=2, corresponding to a ring size of 5 or 6 respectively.

Preferred cyclic ketones of the general formula (1) are cyclopentanone 2-carboxymethyl ester and 2-carboxyethyl ester, cyclopentanone-2-carbonitrile, cyclohexanone 2-carboxymethyl ester and 2-carboxyethyl ester or cyclopentanone-2-carbonylmethane. Particular preference is given to cyclopentanone 2-carboxymethyl ester and 2-carboxyethyl ester and also cyclohexanone 2-carboxymethyl ester and 2-carboxyethyl ester.

The compounds of the general formula (1) are prepared in accordance with German Laid-Open Specification DE 10132016A1.

It is of course also possible to employ the stated CH-acidic cyclic ketones not only in mixtures with one another but also, albeit less preferably, in any desired mixtures with other blocking agents.

Suitable further blocking agents are, for example, alcohols, lactams, oximes, malonic esters, alkyl acetoacetates, triazoles, phenols, imidazoles, pyrazoles and also amines, such as butanone oxime, diissopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-methyl-, N-ethyl-, N-(iso)propyl-, N-n-butyl-, N-isobutyl-, N-tert-butyl-benzylamine or 1,1-dimethylbenzylamine, N-alkyl-N-1,1-dimethylmethylphenylamine, adducts of benzylamine with compounds having activated double bonds such as malonic esters, N,N-dimethylaminopropylbenzylamine and other optionally substituted benzylamines containing tertiary amino groups, and/or dibenzylamine, or any desired mixtures of these blocking agents.

If used at all, the fraction of these further blocking agents other than CH-acidic cyclic ketones is less than 40% by weight, preferably less than 20% by weight, based on the total amount of blocking agent used for blocking.

Preference is given to using exclusively CH-acidic cyclic ketones of the formula (1), particular preference to using exclusively cyclopentanone 2-carboxyethyl ester and/or cyclopentanone 2-carboxymethyl ester.

Catalysts used for the blocking can be alkali metal and alkaline earth metal bases, such as pulverized sodium carbonate (soda), trisodium phosphate, or amine bases such as DABCO (1,4-diazabicyclo[2.2.2]octane), for example. Likewise suitable are the carbonates of the metals of transition group two, and also zinc salts.

Preference is given to sodium carbonate, potassium carbonate or zinc 2-ethylhexanoate.

The free NCO group content of the blocked polyisocyanate prepolymers of the invention is ≦3%, preferably <1% by weight, more preferably <0.1% by weight.

In the process of the invention component B) is reacted with excess amounts of the polyisocyanate component A) optionally in the presence of a catalyst. Subsequently any unreacted polyisocyanate is removed by means of continuous distillation. The molar ratio of the OH groups of the compounds of component B) to the NCO groups of the compound of component A) is preferably 1:≧2.1, more preferably 1:5 to 1:15 and very preferably 1:10 to 1:15.

The reaction of B) with A) takes place in general at temperatures from 0 to 250° C., preferably from 20 to 140° C., more preferably from 40 to 100° C., optionally with the use of a catalyst component.

Subsequently residual monomer present is distilled off by means of continuous distillation down to a residual monomer content of less than 10%. With preference a range of 0 to 5% is achieved, more preferably of 0 to 1%.

By a continuous distillation process in the sense of the invention is meant a process in which only a respective portion of the prepolymer from step I) of the process is briefly exposed to an elevated temperature, whereas the amount not yet within the distillation operation remains at a significantly lower temperature. An elevated temperature means that for the evaporation of the volatile constituents at a correspondingly selected pressure.

The distillation is carried out preferably at a temperature of less than 180° C., more preferably 80 to 160° C., very preferably 100 to 150° C., and at pressures of less than 10 mbar, more preferably less than 2 mbar, very preferably at 1 to 0.01 mbar.

The temperature of the amount of the prepolymer-containing reaction mixture that is not yet within the distillation operation is preferably 0 to 60° C., more preferably 15 to 40° C. and very preferably 20 to 40° C.

In one preferred embodiment of the invention the temperature difference between the distillation temperature and the temperature of the amount of the prepolymer-containing reaction mixture that is not yet within the distillation operation is at least 5° C., more preferably at least 15° C., very preferably 15 to 40° C.

The distillation is preferably performed at a rate such that a volume increment of the prepolymer-containing reaction mixture to be distilled is exposed for less than 10 minutes, more preferably less than 5 minutes, to the distillation temperature and then is brought back, by active cooling where appropriate, to the initial temperature of the prepolymer-containing reaction mixture prior to the distillation. The temperature loading traversed in this procedure is preferably such that the temperature of the reaction mixture prior to the distillation or of the prepolymer after the distillation is at least 5° C., more preferably at least 15° C., very preferably 15 to 40° C. higher than the distillation temperature employed.

Preferred continuous distillation techniques are short-path (flash), falling-film and/or thin-film distillation (in this regard see, for example, Chemische Technik, Wiley-VCH, Volume 1, 5th Edition, pages 333-4).

Falling-film evaporators are composed of a stationary bundle of long tubes, into which the liquid to be evaporated is fed in at the top and flows downwards as a film. Within the jacket space, heating takes place by means of steam. Within the tubes, vapour bubbles are formed, which flow downwards with the liquid and ensure turbulent conditions. Vapour and liquid separate at the bottom end in a settling vessel.

Thin-film evaporators are apparatus suitable for evaporating temperature-sensitive substances which can be subjected to a thermal load only briefly. The liquid to be evaporated is fed at the top into a tube with jacket heating. The liquid flows down the tube as a film. Within the tube a wiper, suspended from a shaft, rotates, and ensures a constant film thickness.

As a continuous distillation technique it is preferred to employ thin-film distillation with the parameters specified above.

To prepare the products of the invention, finally, polyurethane prepolymers thus obtained, containing isocyanate groups, are reacted with the blocking agent, with the use where appropriate of suitable catalysts, at temperatures of 0 to 250° C., preferably 20 to 140° C., more preferably from 30 to 100° C.

The blocking agent is to be used in an amount such that the equivalents of the groups of the blocking agent that are suitable for isocyanate blocking correspond to at least 60 mol %, preferably 75 mol %, more preferably 85 mol % and very preferably more than 95 mol % of the amount of isocyanate groups to be blocked. A small excess of blocking agent may be advantageous in order to ensure complete reaction of all isocyanate groups. In general the excess is not more than 20 mol %, preferably not more than 15 mol % and more preferably not more than 10 mol %, based on the isocyanate groups to be blocked. With very particular preference, therefore, the amount of blocking agent groups suitable for NCO blocking is 95 mol % to 110 mol %, based on the amount of the isocyanate groups of the polyurethane prepolymer that are to be blocked.

In the process of the invention, if catalysts are used, the amount of catalyst added, based on the reaction mixture as a whole, is up to 10% by weight, preferably 0.005% to 5% by weight, more preferably 0.005% to 0.1% by weight.

In general it is possible at any point in time during the preparation of the polyisocyanates of the invention to make use additionally of one or more organic solvents which are inert under the process conditions. Examples of suitable such solvents include triethyl phosphate, chlorobenzene, which are to be understood as being merely by way of example. Preferably the preparation of the products of the invention is carried out without additional solvents.

In one preferred embodiment of the process of the invention component A is charged at a temperature of 70 to 120° C. to a suitable reaction vessel. A mixture of component B is slowly added dropwise to this initial charge. The mixture is subsequently stirred for a certain time until the NCO value has attained the theoretical value.

Subsequently a continuous distillation of the kind specified above is carried out at a temperature of 100 to 150° C. and a pressure of 0.05 to 1 mbar.

To accelerate the subsequent blocking reaction a suitable catalyst is then added, such as zinc(II) 2-ethylhexanoate, for example, the temperature of the reaction mixture before or after addition of the catalyst being adjusted where appropriate to a level of between 50 and 100° C. When the desired temperature has been reached the blocking agent is added and the reaction mixture is heated until the free isocyanate group content is less than 0.5% by weight, preferably less than 0.2% by weight, more preferably less than 0.1% by weight. Thereafter the reaction mixture is cooled and where appropriate also provided with a reaction stopper, such as benzoyl chloride or isophthaloyl dichloride, for example.

The invention additionally provides polyurethane prepolymers which have
i) alkylene oxide ether units, and/or
ii) polyester units, and/or
iii) polyacrylate units, and/or
iv) polycarbonate units, and also
v) structural units of the formula (2) 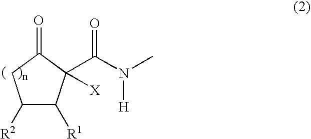
in which
X is a mesomerically or inductively electron-withdrawing group,
R¹ and R² independently of one another can be a hydrogen atom, a saturated or unsaturated aliphatic or cycloaliphatic, an optionally substituted aromatic or araliphatic radical and can each contain up to 12 carbon atoms and optionally up to 3 heteroatoms of the elements oxygen, sulphur and nitrogen, and can optionally be substituted by halogen atoms, and
n is an integer from 0 to 5.

Alkylene oxide ether units i) of the polyurethane prepolymers of the invention correspond to structures of the formula (3), 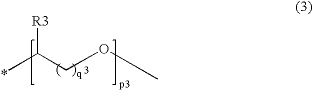
where
R³ is hydrogen or a C1 to C10 alkyl radical and
p³ is a number between 1 to 1000, and
q³ is 1 to 3.

Preferably R³=hydrogen or a methyl group and p is 1 to 300
Polyester units ii) of the polyurethane prepolymers of the invention correspond to the formula (4), 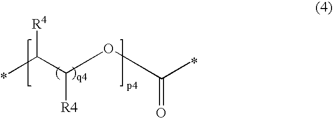
where
R⁴ is hydrogen or a C1 to C10 alkyl radical, optionally also connected to one another, and
p⁴ is a number between 1 to 1000, and
q⁴ is 1 to 14.
Polycarbonate units iv) of the polyurethane prepolymers of the invention correspond to the formula (5), 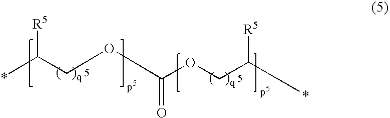
where
R⁵ is hydrogen or a C1 to C10 alkyl radical and
p⁵ is a number between 1 to 1000, and
q⁵ is 1 to 11.
These structures may also proportionately contain carboxylic ester groups.

The new low-viscosity prepolymers described can be formulated as component a) with different amines (component b), and/or polyhydroxy compounds (component c) and optionally with oxirane-containing compounds d) to give reactive systems and can be cured to form coatings. Polyamines used in b) are polyamines which have at least two primary amino groups per molecule and optionally secondary amino groups as well. They preferably have an average molecular weight of 60 to 500 g/mol. Suitable examples include ethylene diamine, 1,2- and 1,3-diaminopropane, 1,4-diaminobutane, 2,2,4- and/or 2,4,4-trimethylhexamethylenediamine, the inductive xylylenediamines, 1,4-diaminocyclohexane, 4,4′-diaminodicyclohexylmethane (PACM 20), 1,3-diaminocyclopentane, 4,4′-diaminodicyclohexyl sulphone, 1,3-bis(4-aminocyclohexyl)propane, 2,2-bis(4-aminocyclohexyl)propane, 2,2′-dimethyl-4,4′-diaminodicyclohexylmethane (Laromin), 3-aminomethyl-3,3,5-trimethylcyclohexylamine (isophoronediamine, IPDA), 3(4)-aminomethyl-1-methylcyclohexylamine, technical bisaminomethyltricyclodecane, octahydro-4,7-methanoindene-1,5-dimethanamine and diethylenetriamine or triethylenetetramine.

Preferred polyamines are those of the aforementioned kind which have one or more cycloaliphatic rings. These include, for example, 1,4-diaminocyclohexane, 4,4′-diaminodicyclohexylmethane, 1,3-diaminocyclopentane, 4,4′-diaminodicyclohexyl sulphone, 1,3-bis(4-aminocyclohexyl)propane, 2,2-bis(4-aminocyclohexyl)propane, 3,3′-dimethyl-4,4′-diaminodicyclohexylmethane, 3-aminomethyl-3,3,5-trimethylcyclohexylamine (isophoronediamine), 3- and 4-aminomethyl-1-methylcyclohexylamine or technical bisaminomethyltricyclodecane.

As a constituent of amine component b) it is possible with advantage to use adducts prepared by reacting an excess of the aforementioned polyamines with epoxy resins of the type specified below.

In component b) it is also possible with advantage to use polyether amines which are prepared by reacting polyether polyols with ammonia and are sold for example by Huntsman (Salt Lake City, US) under the trade name Jeffamin®.

Also suitable with advantage, furthermore, are polyamide resins as amine component b) for the crosslinking of the prepolymer of the invention. Polyamide resins of this kind, which include the polyaminoamides and the polyaminoimidazolines, are sold by, among others, Henkel KGaA Düsseldorf, DE under the trade name “Versamid®”.

It is of course also possible to employ mixtures of the stated polyamines as amine component b).

Suitable polyhydroxy compounds c) are relatively high molecular weight polyether polyols which are known per se from polyurethane chemistry and are obtainable in conventional manner by alkoxylation of suitable starter molecules. The polyethers are preferably based on building blocks of the kind described above in connection with the constituents of component B of the process of the invention.

As a polyhydroxy component c) it is also possible, however, to use polybutanediol polyethers, polyacrylate polyols and polyester polyols.

If desired it is also possible to use oxirane-containing compounds d) as well for curing. Suitability in this context is possessed by epoxy resins which contain on average more than one epoxide group per molecule. Examples of suitable epoxy resins are glycidyl ethers of polyhydric alcohols such as butanediol, hexanediol, glycerol, hydrogenated diphenylolpropane or polyhydric phenols such as resorcinol, 2,2-diphenylolpropane (bisphenol A) diphenylolmethane (bisphenol F) or phenol-aldehyde condensates. Glycidyl esters of polyhydric carboxylic acids, such as hexahydrophthalic acid or dimerized fatty acid, can also be used.

Where epoxides of component d) are used at all, preference is given to the use of liquid epoxy resins based on epichlorohydrin and 2,2-diphenylolpropane (bisphenol A) or diphenylolmethane (bisphenol F) and/or mixtures thereof.

Particular preference is given to the use of lightfast, i.e. aliphatic epoxide compounds. With these it is then possible to produce lightfast coatings together with the described prepolymers of the invention. Suitability is therefore possessed by trimethylolpropane trisglycidyl ether, 4,4′-dihydroxydicyclohexylmethane bisglycidyl ether or other aliphatic epoxide compounds.

If the mixtures are desired to have a low viscosity, their viscosity can be lowered by the use of monofunctional epoxide compounds, thereby improving processing. Examples of such are aliphatic and aromatic glycidyl ethers such as butyl glycidyl ether, phenyl glycidyl ether or glycidyl esters such as Versatic acid glycidyl esters or epoxides such as styrene oxide or 1,2-epoxidodecane and also trimethylolpropane trisglycidyl ether.

In the solvent-free, room temperature-curing reactive systems of the invention the ratio of isocyanate groups to amine groups is 0.8:1 to 1.2:1, preferably 1:1.

Where component d) is added in the solvent-free, room temperature-curing reactive systems of the invention, there are generally 0.4 to 0.9, preferably 0.5 to 0.8, primary amino groups of component b) and/or OH groups of the compounds of component c) and 0.02 to 0.6, preferably 0.03 to 0.5, blocked isocyanate groups of component a) per epoxide group of component d).

For the preparation of ready-to-use mixtures it is possible to incorporate the typical auxiliaries and additives into the reactive systems of the invention, such as, for example, fillers, solvents, flow control assistants, pigments, solvents, reaction accelerants or viscosity regulators. Mention may be made, by way of example, of reaction accelerants such as salicylic acid, bis(dimethylaminomethyl)phenol or tris(dimethylaminomethyl)phenol, fillers such as sands, fine mineral powder, silica, fine asbestos powder, kaolin, talc, metal powders, tar, pitch, asphalts, cork scraps, polyamides, plasticizers such as phthalic esters, for example, or other viscosity regulators such as benzyl alcohol, for example.

It is of course possible for technical application purposes to add if desired up to 20% by weight, preferably up to 10% by weight, more preferably up to 5% by weight, of a solvent, or paint solvent, to the ready-to-use mixture, such as methoxypropyl acetate, butyl acetate, xylene or the like, for example. If solvents are to be used at this point, it is also possible to dispense with the removal of the solvent in the case of the possible use of solvents during the synthesis of the polyurethane prepolymers of the invention.

Very particular preference in the sense of the invention is given, however, to solvent-free, ready-to-use reactive systems.

In the process of the invention for preparing the reactive systems, component a) is mixed in any order with component b) and/or c), preferably with stirring. After that, likewise in any order and again with stirring where appropriate, it is possible to add, additionally, components b) and/or c) and/or d).

The crosslinking of the reactive systems of the invention comprising a) and/or b) and optionally c) and/or d) with polyamines may take place at temperatures of −30° C. and 250° C., preferably at temperatures of −30° C. to 150° C., more preferably at −20° C. to 80° C. and very preferably at 0° C. to 40° C. Curing takes place, with a relative moisture content of preferably 10% to 90%, within a few minutes to several days. Curing can additionally be forced by means of elevated temperatures, i.e. above about 50° C., and this may likewise be desirable in practice. In this case it is even possible for temperatures of up to 250° C. to be obtained for a short time during which the materials are not damaged.

The blocked polyisocyanates of the invention, and also the reactive systems, are suitable for preparing coatings, adhesives, sealants, casting compounds or mouldings in all fields of application requiring good adhesion, chemical resistance, and also high impact strength and collision strength, in association with good flexibility and elasticity. The systems of the invention are especially suitable for use as floor coatings and other coatings. They are notable for high surface quality and high gloss.

The reactive systems of the invention can be applied for example by pouring, brushing, dipping, spraying, flooding, knife coating or rolling to the surface that is to be coated. Depending on the field of application it is therefore possible to obtain different coat thicknesses.

### EXAMPLES

Initial Remarks:

All percentages are to be understood, unless noted otherwise, as percentages by weight (% by weight). Desmophen® and Desmodur® are trade marks of Bayer MaterialScience AG, Leverkusen, DE

The Hazen colour number was determined in accordance with DIN 53995 using a Lico 400 calorimeter from Dr Lange GmbH, Berlin, DE

The viscosity was determined using a Haake Roto Visko 1, disc 3 with D=20 mm, on the plate/plate principle, at T=22.2° C. with Element 5.

The NCO content was assayed in acetone as solvent with a dibutylamine excess and 1 mol/l HCl in accordance with DIN EN ISO 11909.

Polyol A: PO polyether, prepared starting from bisphenol A/trimethylolpropane, OH number 370 mg KOH/g, functionality 2

Desmophen® 550U: PO polyether polyol, OH number 380 mg KOH/g functionality 3

Desmophen® V 3970: PO polyether, functionality 3, OH number 34.8 mg KOH/g

Preparation of TDI Prepolymers for Coatings

1a) Preparation of a TDI Prepolymer with Thin-filming:

A 1 l four-necked flask with reflux condenser, internal thermometer and mechanical stirrer was charged under a nitrogen atmosphere with 516.8 g of TDI (80% 2,4-diisocyanatotoluene and 20% 2,6-diisocyanatotoluene) (5.94 eq, equivalent weight 87 g/eq), 0.41 g of triphenylphosphine and 0.41 g of Ionol (2,4-di-tert-butylphenol) at a temperature of 60° C. Added dropwise to this mixture, slowly over a period of 60 minutes, was a mixture of 254.6 g of Desmophen® V 3970 (0.16 eq, equivalent weight 1591.0 g/eq), 35.8 g of polyol A (0.13 eq, equivalent weight 275.0 g/eq) and 5.8 g of Desmophen® 550U (0.04 eq, equivalent weight 145.8 g/eq). In the course of the addition the temperature did not rise above 70° C. After about 1 hour of subsequent stirring the NCO value of 28.7% (theoretical value 29.0%) was reached. Subsequently a thin-film distillation was carried out over a period of 120 minutes at a temperature of 150° C. and a pressure of 0.05 mbar. The product obtained had an NCO value of 4.2% (theoretical value 3.9%) and an equivalent weight of 1000.0 g/eq). The viscosity was 18 010 mPas. The colour number was 20 [Apha].

The prepolymer obtained in this way was reacted further to form building blocks for coatings.

1b) TDI Prepolymer Formed from Thin-filmed Prepolymer and Featuring Elimination Product-free Blocking:

A 250 ml four-necked flask with reflux condenser, internal thermometer and mechanical stirrer was charged with 90.0 g of the above-described TDI prepolymer 1 (0.09 eq, equivalent weight 1000.0 g/eq) together with 0.05 g of triphenylphosphine, 0.05 g of Ionol (2,4-di-tert-butylphenol), 11.6 g of Rhodiasolv® RPDE (main constituent: diethyl adipate and diethyl glutarate, Rhodia PPMC/FR) and 0.1 g of zinc 2-ethylhexanoate (Borchers GmbH, Langenfeld, DE) at a temperature of 25° C. under a nitrogen atmosphere. Added dropwise to this mixture over a period of 15 minutes was a quantity of 14.1 g of cyclopentanone 2-carboxyethyl ester (0.09 eq, equivalent weight 156.2 g/eq). The resulting mixture was then heated to a temperature of 40° C. It was left to react for six hours, after which an NCO value <0.1% was still detectable. The product obtained had an equivalent weight of 1285.6 g/eq. The viscosity was 18 060 mPas. The colour number was 25 [Apha].

2a) Preparation of a TDI Prepolymer without Thin-filming:

A 500 ml three-necked flask with reflux condenser, internal thermometer and mechanical stirrer was charged under a nitrogen atmosphere with 57.4 g of TDI (T80, 80% 2,4-diisocyanatotoluene and 20% 2,6-diisocyanatotoluene) (0.66 eq, equivalent weight 87 g/eq), 0.18 g of triphenylphosphine and 0.18 g of Ionol (2,4-di-tert-butylphenol) at a temperature of 60° C. Added dropwise to this mixture, slowly over a period of 60 minutes, was a mixture of 254.6 g of Desmophen® V 3970 (0.16 eq, equivalent weight 1591.0 g/eq), 35.8 g of polyol A (0.13 eq, equivalent weight 275.0 g/eq) and 5.8 g of Desmophen® 550U (0.04 eq, equivalent weight 145.8 g/eq). In the course of the addition the temperature did not rise above 70° C. After about three hours of subsequent stirring the NCO value of 3.75% (theoretical value 3.9%) was reached. The product obtained had an equivalent weight of 1120 g/eq). The viscosity was 18 320 mPas. The colour number was 20 [Apha].

The prepolymer obtained in this way was reacted further to form building blocks for coatings.

2b) TDI Prepolymer Formed from Non-thin-filmed Prepolymer and Featuring Elimination Product-free Blocking:

A 250 ml four-necked flask with reflux condenser, internal thermometer and mechanical stirrer was charged with 89.6 g of the above-described TDI prepolymer 1 (0.08 eq, equivalent weight 1120 g/eq) together with 0.05 g of triphenylphosphine, 0.05 g of Ionol (2,4-di-tert-butylphenol), 11.6 g of Rhodiasolv® RPDE (main constituent: diethyl adipate and diethyl glutarate, Rhodia PPMC/FR) and 0.11 g of zinc 2-ethylhexanoate (Borchers GmbH, Langenfeld, DE) at a temperature of 25° C. under a nitrogen atmosphere. Added dropwise to this mixture over a period of 15 minutes was a quantity of 14.1 g of cyclopentanone 2-carboxyethyl ester (0.09 eq, equivalent weight 156.2 g/eq). The resulting mixture was then heated to a temperature of 40° C. It was left to react for five hours, after which an NCO value <0.1% was still detectable. The product obtained had an equivalent weight of 1285.6 g/eq. The viscosity was 35 400 mPas. The colour number was 25 [Apha].

Comparison: Prepolymer with thin-filming: 18 010 mPas

Prepolymer without thin-filming: 18 320 mPas
Blocked prepolymer 2, 90% SC 35 400 mPas
Blocked prepolymer 1, 90% SC 18 060 mPas
   Preparation Instructions for HDI Prepolymers with/without Thin-filming
   3a) Preparation of a Hexamethylene Diisocyanate (HDI) Polyether Prepolymer with Thin-filming:

A 2 l four-necked flask with reflux condenser, internal thermometer and mechanical stirrer was charged under a nitrogen atmosphere with 1372.1 g of HDI (16.3 eq, equivalent weight 84 g/eq), 0.98 g of triphenylphosphine and 0.98 g of Ionol (2,4-di-tert-butylphenol) at a temperature of 100° C. Added dropwise to this mixture, slowly over a period of 60 minutes, was a mixture of 442.5 g of Desmophen® V 3970 (0.27 eq, equivalent weight 1609.2 g/eq), 123.5 g of polyol A (0.44 eq, equivalent weight 280.7 g/eq) and 30.6 g of Desmophen® 550U (0.19 eq, equivalent weight 159.1 g/eq). In the course of the addition the temperature did not rise above 105C. After about four hours of subsequent stirring the NCO value of 32.5% (theoretical value 32.9%) was reached. Subsequently a thin-film distillation was carried out over a period of 8 hours at a temperature of 150° C. and a pressure of 0.05 mbar. The product obtained had an NCO value of 4.9% (theoretical value 5.1%) and an equivalent weight of 857.1 g/eq). The viscosity was 4400 mPas. The colour number was about 50 [Apha].

The prepolymer obtained in this way was reacted further to form building blocks for coatings.

3b) Thin-filmed Polyether Prepolymer Based on Hexamethylene Diisocyanate and Featuring Elimination Product-free Blocking (Inventive):

A 250 ml four-necked flask with reflux condenser, internal thermometer and mechanical stirrer was charged with 85.7 g of the above-described HDI prepolymer 1 (0.1 eq, equivalent weight 857.1 g/eq) together with 0.05 g of triphenylphosphine, 0.05 g of Ionol (2,4-di-tert-butylphenol), and 0.11 g of zinc neodecanoate (95% purity) at a temperature of 25° C. under a nitrogen atmosphere. The triphenylphosphine, Ionol and the catalyst had been dissolved beforehand in 0.5 g of Rhodiasolv® RPDE (main constituent: diethyl adipate and diethyl glutarate, Rhodia PPMC/FR). Added dropwise to this mixture over a period of 30 minutes was a quantity of 14.2 g of cyclopentanone 2-carboxyethyl ester (0.1 eq, equivalent weight 142.2 g/eq). The resulting mixture was then heated to a temperature of 40° C. It was left to react for 2 h, after which no NCO value was detectable. The product obtained had an equivalent weight of 1007.1 g/eq. The viscosity was 39 500 mPas. The colour number was about 50 [Apha].

3c) Nonylphenol-blocked, Thin-filmed Polyether Prepolymer Based on Hexamethylene Diisocyanate (Comparative):

A 25 ml two-necked flask with internal thermometer was charged with 8.3 g of the thin-filmed HDI polyether prepolymer 3a) (equivalent weight 857.1 g/mol, 1 eq). Added to this were 2.2 g of nonylphenol (equivalent weight 220.4 g/mol, 1 eq). This mixture was stirred with a good stirring action at a temperature of 60° C. under a nitrogen atmosphere until the product no longer had an NCO value. The viscosity of the product was approximately 100 000 mPas. The colour number was approximately 50 [Apha].

3d) Preparation of a Hexamethylene Diisocyanate (HDI) Polyether Prepolymer without Thin-film Technique

A 100 ml four-necked flask with reflux condenser, internal thermometer and mechanical stirrer was charged under a nitrogen atmosphere with 22.2 g of HDI (hexamethylene diisocyanate) (0.264 eq, equivalent weight 84 g/eq), 0.05 g of triphenylphosphine and 0.05 g of Ionol (2,4-di-tert-butylphenol) at a temperature of 100° C. Added dropwise to this mixture, slowly over a period of 60 minutes, was a mixture of 64.4 g of Desmophen® V 3970 (0.04 eq, equivalent weight 1609.2 g/eq), 18.0 g of polyol A (0.064 eq, equivalent weight 280.7 g/eq) and 4.5 g of Desmophen® 550U (0.028 eq, equivalent weight 159.1 g/eq). In the course of the addition the temperature did not rise above 105° C. After about four hours of subsequent stirring the NCO value of 4.7% (theoretical value 5.08%) was reached. The product has an equivalent weight of 893.6 g/eq). The viscosity was 33 100 mPas.

3e) Non-thin-filmed Polyether Prepolymer Based on Hexamethylene Diisocyanate and Featuring Elimination Product-free Blocking (Comparative):

A 250 ml four-necked flask with reflux condenser, internal thermometer and mechanical stirrer was charged with 71.5 g of the above-described HDI prepolymer (0.08 eq, equivalent weight 893.6 g/eq) with 0.09 g of zinc neodecanoate (SC: 95% purity) at a temperature of 25° C. under a nitrogen atmosphere. Added dropwise to this mixture over a period of 15 minutes was a quantity of 11.4 g of cyclopentanone 2-carboxymethyl ester (0.08 eq, equivalent weight 142.2 g/eq). The resulting mixture was then heated to a temperature of 40° C. It was left to react for nine hours, after which no NCO value was detectable. The product obtained had an equivalent weight of 1037.4 g/eq. The viscosity was 192 000 mPas.

3f) Nonylphenol-blocked, Non-thin-filmed Polyether Prepolymer Based on Hexamethylene Diisocyanate (Comparative):

A 25 ml two-necked flask with internal thermometer was charged with 8.3 g of the thin-filmed HDI polyether prepolymer 3d) (equivalent weight 893.6 g/mol, 1 eq). Added to this were 2.2 g of nonylphenol (equivalent weight 220.4 g/mol, 1 eq). This mixture was stirred with a good stirring action at a temperature of 60° C. under a nitrogen atmosphere until the product no longer had an NCO value. The viscosity of the product was >>250 000 mPas. The colour number was approximately 50 [Apha].

Comparison: HDI prepolymer with thin-filming (1): 4400 mPas

HDI prepolymer without thin-filming (2): 33 100 mPas
CPME-blocked prepolymer 1 39 500 mPas
CPME-blocked prepolymer 2 192 000 mPas
Nonylphenol-blocked prepolymer 1 100 000 mPas
Nonylphenol-blocked prepolymer 2 >250 000 mPas

As is apparent from the examples above, in terms of the viscosity it is irrelevant in the case of TDI-based prepolymers whether residual monomer separation by continuous distillation is carried out or not. In the case of the HDI-based prepolymers, in contrast, a significant drop in viscosity to 4400 as against 33 100 occurs in the case of thin-film distillation.

In the course of subsequent blocking the viscosity rises in the case of the HDI system, with products of the process of the invention achieving distinctly lower values overall than in the case of the comparative experiments, where no thin-film distillation was carried out.

4a) HDI PO Polyether Urethane Prepolymer

A 2 l four-necked flask with reflux condenser, internal thermometer and mechanical stirrer was charged under a nitrogen atmosphere with 420 g of HDI (5 eq, equivalent weight 84 g/eq) at a temperature of 100° C. Added dropwise to this mixture, slowly over a period of 60 minutes, was a mixture of 804.6 g of Desmophen® V 3970 (0.5 eq, equivalent weight 1609.2 g/eq). During the addition the temperature did not rise above 105° C. After about four hours of subsequent stirring the NCO value of 15.43% (theoretical value) was reached. Subsequently a thin-film distillation was carried out over a period of 6 hours at a temperature of 150° C. and a pressure of 0.05 mbar. The product obtained had an NCO value of 1.85% (theoretical value) and an equivalent weight of 2270.3 g/eq). The residual monomer content was 0.03%. The viscosity was 4400 mPas. The colour number was about 30 [Apha].

4b) PO Polyether Prepolymer Based on Hexamethylene Diisocyanate, with Elimination Product-free Blocking (Inventive):

A 1000 ml four-necked flask with reflux condenser, internal thermometer and mechanical stirrer was charged at a temperature of 25° C. under a nitrogen atmosphere with 681.1 g of the above-described HDI prepolymer (0.33 eq, equivalent weight 2270.3 g/eq) together with 0.36 g of zinc 2-ethylhexanoate. Added dropwise to this mixture over a period of 30 minutes was an amount of 42.7 g of cyclopentanone 2-carboxymethyl ester (0.33 eq, equivalent weight 142.2 g/eq). The resulting mixture was subsequently heated to a temperature of 40° C. It was left to react for 2 h hours, after which no NCO value was detectable. The product obtained had an equivalent weight of 2413.8 g/eq. The viscosity was 43 500 mPas. The colour number was about 30 [Apha].

4c) HDI PO/EO Polyether Urethane Prepolymer

A 1 l four-necked flask with reflux condenser, internal thermometer and mechanical stirrer was charged under a nitrogen atmosphere with 252 g of HDI (3.3 eq, equivalent weight 84 g/eq) at a temperature of 100° C. Added dropwise to this mixture, slowly over a period of 60 minutes, was 357.5 g of Desmophen® V 3970 (0.3 eq, equivalent weight 1191.5 g/eq). During the addition the temperature did not rise above 105° C. After about four hours of subsequent stirring the NCO value of 18.61% (theoretical value) was reached. Subsequently a thin-film distillation was carried out over a period of 2 hours at a temperature of 150° C. and a pressure of 0.05 mbar. The product obtained had an NCO value of 2.55% (theoretical value). The residual monomer content was 0.03%. The viscosity was 14 000 mPas. The colour number was about 30 [Apha].

4d) PO Polyether Prepolymer Based on Hexamethylene Diisocyanate, with Elimination Product-free Blocking (Inventive):

A 250 ml four-necked flask with reflux condenser, internal thermometer and mechanical stirrer was charged at a temperature of 25° C. under a nitrogen atmosphere with 164.7 g of the above-described HDI prepolymer (0.1 eq, equivalent weight 1647.1 g/eq) together with 0.09 g of zinc 2-ethylhexanoate. Added dropwise to this mixture over a period of 30 minutes was an amount of 15.62 g of cyclopentanone 2-carboxymethyl ester (0.1 eq, equivalent weight 156.2 g/eq). The resulting mixture was subsequently heated to a temperature of 40° C. It was left to react for 2 h hours, after which no NCO value was detectable. The product obtained had an equivalent weight of 1803.3 g/eq. The viscosity was 43 500 mPas. The colour number was about. 35 [Apha].

4e) HDI C4 Polyether Urethane Prepolymer

A 5 l four-necked flask with reflux condenser, internal thermometer and mechanical stirrer was charged under a nitrogen atmosphere with 1092 g of HDI (13 eq, equivalent weight 84 g/eq) at a temperature of 100° C. Added dropwise to this mixture, slowly over a period of 60 minutes, was a mixture of 632.5 g of Terathane® 1000 (C4 polyether based on THF, DuPont, USA) (1.3 eq, equivalent weight 486.5 g/eq). During the addition the temperature did not rise above 105° C. After about two hours of subsequent stirring the NCO value of 28.5% was reached. Subsequently a thin-film distillation was carried out over a period of 4 hours at a temperature of 150° C. and a pressure of 0.05 mbar. The product obtained had an NCO value of 5.7%. The residual monomer content was 0.03%. The viscosity was 2330 mPas. The colour number was about 30 [Apha].

4f) C4 Polyether Prepolymer Based on Hexamethylene Diisocyanate, with Elimination Product-free Blocking (Inventive):

A 500 ml three-necked flask with reflux condenser, internal thermometer and mechanical stirrer was charged at a temperature of 25° C. under a nitrogen atmosphere with 294.7 g of the above-described HDI prepolymer (0.4 eq, equivalent weight 736.8 g/eq) together with 0.176 g of zinc 2-ethylhexanoate. Added dropwise to this mixture over a period of 30 minutes was an amount of 56.9 g of cyclopentanone 2-carboxyethyl ester (0.4 eq, equivalent weight 142.2 g/eq). The resulting mixture was subsequently heated to a temperature of 40° C. It was left to react for 4 hours, after which no NCO value was detectable. The product obtained had an equivalent weight of 879 g/eq. The viscosity was 16 400 mPas. The colour number was about 35 [Apha].

5a) HDI Polyester Polyol Urethane

A 1 l four-necked flask with reflux condenser, internal thermometer and mechanical stirrer was charged under a nitrogen atmosphere with 420 g of HDI (5 eq, equivalent weight 84 g/eq) at a temperature of 1 00° C. Added dropwise to this mixture, slowly over a period of 60 minutes, was a mixture of 200 g of a poly-ε-caprolactone polyester (0.5 eq, equivalent weight 400 g/eq). This polyester is obtainable by reacting, for example, butane-1,4-diol as starter with ε-caprolactone in the presence of the catalyst tin 2-ethylhexanoate. During the addition the temperature did not rise above 105° C. After about four hours of subsequent stirring the NCO value of 30.3% was reached. Subsequently a thin-film distillation was carried out over a period of 2 hours at a temperature of 150° C. and a pressure of 0.05 mbar. The product obtained had an NCO value of 6.85% (theoretical value) and an equivalent weight of 613.1 g/eq). The residual monomer content was 0.03%. The viscosity was 2530 mPas. The colour number was about 30 [Apha].

5b) Prepolymer Based on Hexamethylene Diisocyanate Featuring Elimination Product-free Blocking and a Poly-ε-caprolactone Polyester (Inventive):

A 1000 ml four-necked flask with reflux condenser, internal thermometer and mechanical stirrer was charged at a temperature of 25° C. under a nitrogen atmosphere with 122.6 g of the above-described HDI prepolymer (0.2 eq, equivalent weight 613.1 g/eq) together with 0.08 g of zinc 2-ethylhexanoate. Added dropwise to this mixture over a period of 30 minutes was an amount of 31.2 g of cyclopentanone 2-carboxyethyl ester.(0.2 eq, equivalent weight 156.2 g/eq, functionality 2). The resulting mixture was subsequently heated to a temperature of 40° C. It was left to react for 2 h hours, after which no NCO value was detectable. The product obtained had a blocked NCO value of 5.46%. The viscosity was 23 600 mPas. The colour number was about 30 [Apha].

6a) HDI Polycarbonate Polyol Urethane

A 2 l four-necked flask with reflux condenser, internal thermometer and mechanical stirrer was charged under a nitrogen atmosphere with 1092 g of HDI (13 eq, equivalent weight 84 g/eq) at a temperature of 100° C. Added dropwise to this mixture, slowly over a period of 60 minutes, was a mixture of 627.3 g of a polycarbonate diol based on 3-methyl-1,5-pentane diol with a molecular weight of approximately 650 g/mol (1.3 eq, equivalent weight 482.5 g/eq). During the addition the temperature did not rise above 105° C. After about 1.5 hours of subsequent stirring the NCO value of 27.9% was reached. Subsequently a thin-film distillation was carried out over a period of 2 hours at a temperature of 150° C. and a pressure of 0.05 mbar. The product obtained had an NCO value of 7.3% (theoretical value) and an equivalent weight of 575.3 g/eq). The residual monomer content was 0.03%. The viscosity was about 120 000 mPas. The colour number was about 30 [Apha].

6b) Prepolymer Based on Hexamethylene Diisocyanate Featuring Elimination Product-free Blocking and a Polycarbonate Polyol (Inventive):

A 2000 ml four-necked flask with reflux condenser, internal thermometer and mechanical stirrer was charged at a temperature of 25° C. under a nitrogen atmosphere with 805.4 g of the above-described HDI prepolymer (1.4 eq, equivalent weight 573.3 g/eq) together with 0.502 g of zinc 2-ethylhexanoate. Added dropwise to this mixture over a period of 30 minutes was an amount of 198.8 g of cyclopentanone 2-carboxymethyl ester (1.4 eq, equivalent weight 142 g/eq). The resulting mixture was subsequently heated to a temperature of 40° C. It was left to react for 2 h hours, after which no NCO value was detectable. The viscosity was 305 000 mPas. The colour number was about 30 [Apha].

An analogously prepared prepolymer for which the thin-film distillation of the invention was not carried out was no longer fluid [viscosity measurement not possible].

7a) HDI Polyacrylate Polyol Urethane

A 2 l four-necked flask with reflux condenser, internal thermometer and mechanical stirrer was charged under a nitrogen atmosphere with 420 g of HDI (5 eq, equivalent weight 84 g/eq) at a temperature of 100° C. Added dropwise to this mixture, slowly over a period of 60 minutes, was a mixture of 444.4 g of a polyacrylate polyol Acryflow® P60 (Lyondell, US) (0.5 eq, equivalent weight 888.9 g/eq). The polyacrylate polyol was heated gently during the addition. During the addition the temperature did not rise above 105° C. After about 1.5 hours of subsequent stirring the NCO value of 21.9% was reached. Subsequently a thin-film distillation was carried out over a period of 2 hours at a temperature of 150° C. and a pressure of 0.05 mbar. The product obtained had an NCO value of 3.35% (theoretical value) and an equivalent weight of 1253.7 g/eq. The residual monomer content was 0.03%. The viscosity was 180 000 mPas. The colour number was about 30 [Apha].

7b) Prepolymer Based on Hexamethylene Diisocyanate Featuring Elimination Product-free Blocking and a Polyacrylate Polyol:

A 2000 ml four-necked flask with reflux condenser, internal thermometer and mechanical stirrer was charged at a temperature of 25° C. under a nitrogen atmosphere with 960 g of the above-described HDI prepolymer (0.8 eq, equivalent weight 1200 g/eq) together with 0.537 g of zinc 2-ethylhexanoate. Added dropwise to this mixture over a period of 30 minutes was an amount of 113.6 g of cyclopentanone 2-carboxymethyl ester (1.4 eq, equivalent weight 142 g/eq). The resulting mixture was subsequently heated to a temperature of 40° C. It was left to react for 2 h hours, after which no NCO value was detectable. The viscosity was 295 000 mPas. The colour number was about 30 [Apha].

An analogously prepared prepolymer for which the thin-film distillation of the invention was not carried out was no longer fluid [viscosity measurement not possible].

The prepolymer 3b), with blocking free from elimination products, was reacted with various amines to form coatings. The properties of the coatings are described in the table below:

| | Example | | |
|---|---|---|---|
| | 1 | 2 | 3 |
| B1. prepolymer 3b) (HDI) | 100 | 100 | 100 |
| Laromin C 260 | 12.1 | | |
| PACM 20 1:1 IPA | | 21.3 | |
| IPDA | | | 8.6 |
| Control agent | 1.1 | 1.2 | 1.1 |
| Pot life | 60 min | 45-60 min | 15 min |
| Modulus 100% [MPa] | 2.9 | 1.5 | 1.2 |
| 0 value | 16.7/760 | 6.4/630 | 7.5/820 |
| Optical quality | very good | very good | very good |

Drying conditions: baking oven, temperature 100-130-170° C., slow-speed belt, coated at 200 μm wet onto super-matt BOR. Measurement in accordance with DIN 53504.

0 value (breaking extension), force in MPa expended in order to cause the film to tear; also indicated is the achievable extension in per cent

Modulus: force in MPa required to bring about a 100% extension

The coatings obtained exhibit good 0 values with outstanding optical quality.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing blocked polyurethane prepolymers, by reacting
I)
A) linear aliphatic isocyanates with
B) one or more polyols optionally in the presence of one or more catalysts to give NCO-functional prepolymers and
II) then subjecting these prepolymers to continuous distillation and lowering residual monomer content to less than 10% by weight of the total amount of the solvent-free prepolymer, and
III) then reacting the free NCO groups of the prepolymers obtained by step II), optionally in the presence of one or more catalysts, with a blocking agent comprising at least one CH-acidic cyclic ketone of the general formula (1), 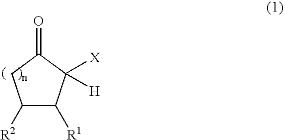
in which
X is a mesomerically or inductively electron-withdrawing group,
R¹ and R² independently of one another can be a hydrogen atom, a saturated or unsaturated aliphatic or cycloaliphatic, an optionally substituted aromatic or araliphatic radical and can each contain up to 12 carbon atoms and optionally up to 3 heteroatoms of the elements oxygen, sulphur and nitrogen, and can optionally be substituted by halogen atoms, and
n is an integer from 0 to 5.

2. Process according to claim 1, wherein the electron-withdrawing group X of the CH-acidic cyclic ketone is an ester, sulphoxide, sulphone, nitro, phosphonate, nitrile, isonitrile or carbonyl group.

3. Process according to claim 1, wherein the residual monomer content is lowered to less than 1% by weight of the total amount of the solvent-free prepolymer.

4. Blocked polyurethane prepolymers obtained by the process according to claim 1.

5. Blocked polyurethane prepolymers based on aliphatic isocyanates which have
i) alkylene oxide ether units, and/or
ii) polyester units, and/or
iii) polyacrylate units, and/or
iv) polycarbonate units, and also
v) structural units of the formula (2) 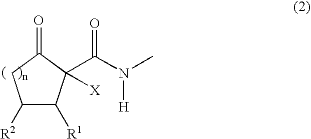
in which
X is a mesomerically or inductively electron-withdrawing group,
R¹ and R² independently of one another can be a hydrogen atom, a saturated or unsaturated aliphatic or cycloaliphatic, an optionally substituted aromatic or araliphatic radical and can each contain up to 12 carbon atoms and optionally up to 3 heteroatoms of the elements oxygen, sulphur and nitrogen, and can optionally be substituted by halogen atoms, and
n is an integer from 0 to 5.

6. Blocked polyurethane prepolymers according to claim 5, wherein the electron-withdrawing group X is an ester, sulphoxide, sulphone, nitro, phosphonate, nitrile, isonitrile or carbonyl group.

7. Blocked polyurethane prepolymers according to any of the claims 4 or 5, wherein they are based on HDI as aliphatic isocyanate.

8. Coatings, adhesives, elastomers, sealants and mouldings comprising the blocked polyurethane prepolymers of any of the claims 4 or 5.

9. Reactive systems comprising
a) blocked polyurethane prepolymers according to any of the claims 4 or 5
b) polyamines and/or
c) polyhydroxy compounds and/or
d) optionally compounds containing oxirane groups.

10. Coatings obtained from reactive systems according to claim 9.

11. Substrates coated with coatings according to claim 10.
